(19) United States
(12) Patent Application Publication
(10) Pub. No.: US 2007/0082293 A1
(43) Pub. Date: Apr. 12, 2007

(54) Method of producting a fluorescent optical information carrier and the apparatus and carrier thereof

(75) Inventors: Reinhold Wimmberger-Friedl, Eindhoven (NL); Milan Saalmink, Eindhoven (NL); Michel Marcel Decre, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/578,980

(22) PCT Filed: Nov. 9, 2004
(86) PCT No.: PCT/IB04/03729

§ 371 Date: May 11, 2006

(30) Foreign Application Priority Data
Nov. 14, 2003 (EP) 03300214.8

(51) Int. Cl. G11B 7/24

(52) U.S. Cl. 430/270.11

(57) ABSTRACT

The present invention relates to a method of producing high contrast optical storage discs. The method comprises usage of so-called liquid embossing technology process steps that turn out to be beneficial for mass-producing fluorescent optical data storage discs. The present invention also relates to a high contrast optical storage disc comprising an information layer that includes a fluorescent dye on a substrate. The information layer comprises a structure of lands and pits and wherein the lands have a thickness of substantially zero; and the pits have a finite thickness. The optical storage disc may well be multi-layered. The present invention also relates to an apparatus suitable for producing high contrast optical fluorescent storage discs.

### FIELD OF THE INVENTION

The present invention relates to a method of manufacturing a fluorescent optical information carrier.

The present invention also relates to a fluorescent optical information carrier.

Moreover the present invention relates to an apparatus for manufacturing a fluorescent optical information carrier.

The present invention is particularly relevant for optical data storage and the production of an optical data storage disc, especially for a high contrast multilayer fluorescent optical disc that can be used as data storage medium.

### BACKGROUND OF THE INVENTION

In the field of optical recording, increasing the capacity of the information carrier is the trend. An already investigated way for increasing the data capacity consists in using a plurality of information layers in the information carrier. For example, a DVD (Digital Video Disc) can comprise two information layers. Information is recorded on or read from an information layer by means of an optical beam, using local refractive index variations or the presence of surface relief structures.

In order to increase the number of layers of an information carrier, a fluorescent multi-layer information carrier has been proposed. Such a fluorescent multi-layer information carrier, as well as an optical disc apparatus for reading from this carrier, is described in patent U.S. Pat. No. 6,009,065, granted on Dec. 28, 1999.

In each information layer, the information is deposited or recorded as a sequence of fluorescent and non-fluorescent cells, the fluorescent cells being made of a fluorescent material capable of generating a fluorescent radiation when interacting with an optical beam. The layers of the carrier are separated by spacer layers, which are transparent for the wavelengths of the optical beam and the fluorescent radiation.

The optical beam is focused with an objective lens on a layer of the carrier. When a fluorescent cell of the addressed layer absorbs the energy of the optical beam, a fluorescence signal is generated. This fluorescence signal has a wavelength, which is different from the wavelength of the exciting beam, due to the so-called Stokes-shift. Hence, the interactions between the fluorescence signal and the non-addressed layer are relatively small, because the absorption of the non-addressed layers at the wavelength of the fluorescence signal is relatively small.

A detector unit then detects the fluorescence signal. The detector unit comprises means for separating the fluorescence signal coming from the addressed layer from the fluorescence signals coming from the non-addressed layers. For example, a co-focal pinhole is inserted in front of a photodiode in order to spatially block the fluorescence signal coming from the non-addressed layers.

Fluorescent data storage is interesting for application in multi-layer media systems because of the photo-induced emission of light, which is incoherent and of a different wavelength as the excitation beam. Therefore no adverse interference effects occur between photons coming from different layers. In contrast to phase grating systems, however, the contrast of the emission between a ‘one’ and a ‘zero’ is not achieved by interference of the refracted or reflected beam. It is achieved solely by the difference in the intensity of the emitted light. The two possibilities for modulation of emission are spatial modulation of absorbance and or emittance. Both possibilities can be achieved via an effective local concentration of dye per unit area of beam diameter. This effective local concentration can be modulated either as a concentration in the chemical sense (molecules per unit of volume) or the physical sense (absorbance per molecule) or simply as the variation in layer thickness. The latter is the most obvious although variation of the absorbance by variation of the molecular orientation (transition moment with respect to the incoming polarized beam) has been proposed.

Variation in layer thickness to create a data-layer can be achieved by (i) structuring a substrate on which the fluorescent layer is applied by spin coating or (ii) by structuring the fluorescent layer after application on a flat substrate by embossing. The former approach (i) is sketched in FIG. 1. The substrate can be structured with the same technology as used for conventional optical recording media (ROM), like injection molding. A problem with this approach is that with spin coating a continuous layer is formed, which after drying will have a modulation in layer thickness but the layer thickness will not be zero. Increasing the depth of the pits can increase the modulation but the replication process of such structures limits this. The second approach (ii), as sketched in FIG. 2, suffers from a similar problem. The ratio of layer thickness in the pit vs. on the land is limited by the fact that it is not possible to reduce the layer thickness in the lands to zero and the aspect ratio of the pit structures is limited by the replication process. Prior art process steps are shown in FIG. 1 for producing a fluorescent layer on a structured substrate for an information carrier disc. In step 100 a structured substrate 104 is taken on which a fluorescent layer 102 is applied. Substrate 104 can be structured using similar technology as used for conventional optical recording media (such as ROM), like injection molding. After the step 110 of spin coating that forms a continuous layer and after drying layer 108 is formed. Lands will however have a thickness unequal to zero.

Prior art process steps are shown in FIG. 2 for producing a structured fluorescent layer on an un-structured substrate for an information carrier disc. In step 200 a hard stamp 202 is used with an unstructured substrate 206 on which a fluorescent layer 204 is applied. In step 210 hard stamp 202 is applied and fluorescent layer 204 will be deformed to a structured fluorescent layer 208. In step 220 the hard stamp 202 will be removed and a final structured fluorescent layer 210 is formed, possibly after a step of hardening. As stamp 202 is hard it will not be possible using this method to achieve a structured surface wherein the lands have a thickness of zero (or even not close to zero).

Producing a disc with a fluorescent data layer with a highest possible contrast between pits and lands turns out not to be feasible until now. An essential step in improving the modulation would be the reduction of emission in the land (or pit) to virtually zero. On top of this, for an optical ROM medium, a process is preferred that structures a whole layer in a single step in order to speed-up the process and to make it at cheap as possible.

### SUMMARY OF THE INVENTION

It is, accordingly, an object of the present invention to provide an easily practiced, low cost process for producing an optical information layer on a substrate and an apparatus enabled to perform the process. The process is especially suited for optical storage discs for which it must be possible to be mass-produced such as read only optical discs (or hybrid discs thereof). The method is targeted for fluorescent optical storage discs that and these discs may be multi layered.

It is another object of the invention to provide an optical storage disc comprising an information layer that includes a fluorescent dye on a substrate. The information layer comprises a structure of lands and pits and wherein the lands have a thickness of substantially zero; and the pits have a finite thickness.

In order to maximize modulation of the information layer the inventor proposes to structure a fluorescent medium in a way that the layer thickness becomes virtually zero in the land (or pit) areas, whereas it has the required thickness for a strong signal in the remaining areas. For a multi-layer medium the inventor found a strong preference to have the continuous (land) area with zero thickness and the pits with maximum thickness in order to minimize background radiation from different layers.

In one embodiment, e.g., starting from a medium as obtained by the processes (i) and (ii) (as described above and if FIG. 1 and FIG. 2 respectively) the inventor achieved the goal by etching the structured fluorescent layer, for instance in a reactive-ion etcher (RIE). In such a process material is removed from the surface by ion bombardment, as sketched in FIG. 3. It will be removed preferentially in the direction perpendicular to the surface. In this way the lateral resolution of the pattern is not affected. [The etching plasma composition can be chosen such that there is a strong difference in etching rate between the fluorescent layer and the substrate (or a coating applied between substrate and fluorescent layer). In this way the etching will virtually stop at the interface.] The potential disadvantages of this approach are the extra etching steps, which add cost to the medium and the potential damage to the fluorescent dyes during etching.

In another embodiment, a preferred technique to achieve a virtually zero thickness involves the so-called liquid embossing process. In this process the structuring is carried out in a liquid layer with the aid of a soft stamp. Liquid embossing techniques have until now only been envisioned for use in the semiconductor technology and alike (see also WO0120402-A1 “Fabrication of finely featured devices by liquid embossing”). The inventor shows how to apply liquid embossing technology for producing a high contrast fluorescent data storage medium. This technology is especially interesting for optical storage media that comprise Read Only Memory (ROM) since they typically need to be produced in mass.

These and other aspects of the invention will be apparent from and will be elucidated with reference to the embodiments described hereinafter.

### BRIEF DESCRIPTION OF THE DRAWINGS

The present invention will now be described in more detail, by way of example, with reference to the accompanying drawings, wherein:

FIG. 1 shows prior art steps of producing a fluorescent layer on a structured substrate;

FIG. 2 shows prior art steps of producing a structured fluorescent layer on a flat substrate by embossing;

FIG. 3 shows steps of producing a structured fluorescent layer on a flat substrate by embossing followed by etching in accordance with the invention;

FIG. 4a shows steps of producing a fluorescent information carrier disc in accordance with the invention;

FIG. 4b shows alternative steps of producing a fluorescent information carrier disc in accordance with the invention;

FIG. 5 shows an apparatus for producing a fluorescent information carrier disc in accordance with the invention that also shows stages or steps of producing the disc;

FIG. 6 shows an alternative apparatus for producing a fluorescent information carrier disc in accordance with the invention that also shows stages or steps of producing the disc; and

FIG. 7 shows yet another apparatus for producing a fluorescent information carrier disc in accordance with the invention that also shows stages or steps of producing the disc.

Throughout the drawings, the same reference numeral refers to the same element, or an element that performs substantially the same function.

### DETAILED DESCRIPTION OF THE INVENTION

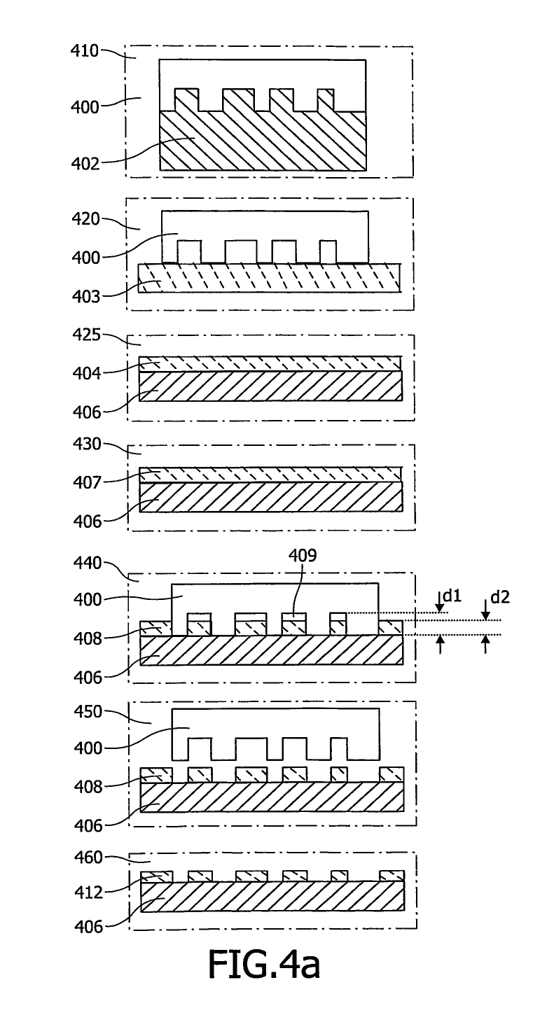

FIG. 3 shows steps of producing a structured fluorescent layer on a flat substrate by embossing followed by etching in accordance with the invention.

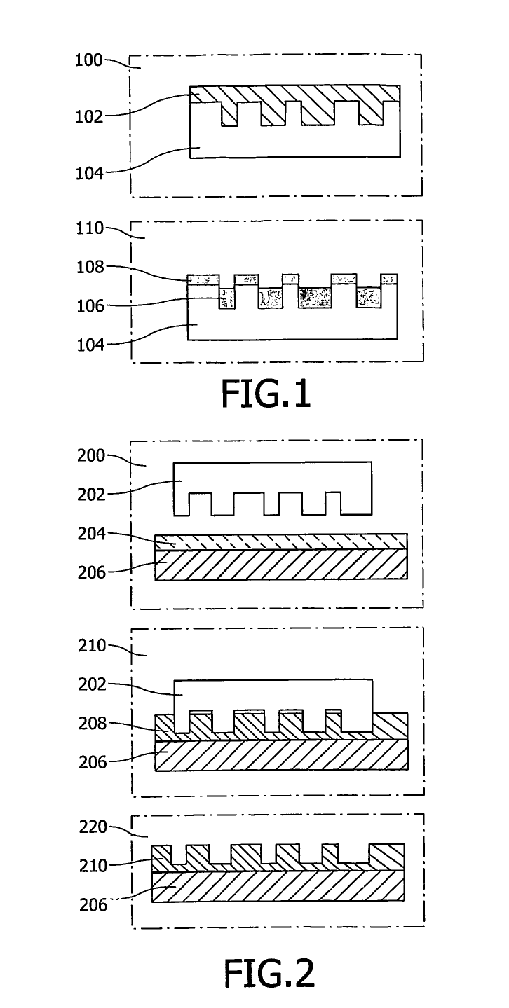

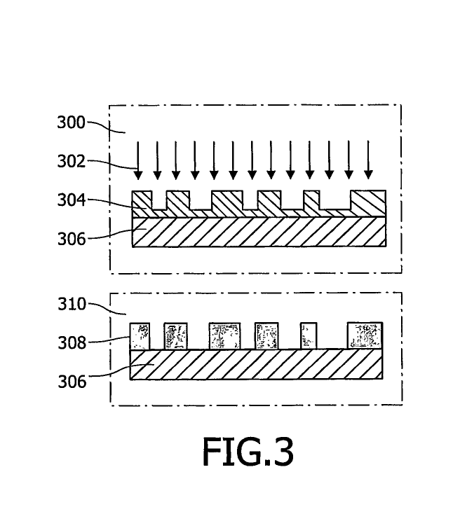

Step 300 of FIG. 3 starts from a medium as obtained by the processes (i) and (ii) (as described FIG. 1 and FIG. 2 respectively). In step 300, structured fluorescent layer 304 is etched, e.g., in a reactive-ion etcher (RIE). In such a process material from layer 304, which resides on carrier 306, is removed from the surface by ion bombardment. It will be removed preferentially in the direction perpendicular to the surface. In this way the lateral resolution of the pattern is not affected. The etching continues until fluorescent 304 is removed at the pits. The etching plasma composition can be chosen such that there is a strong difference in etching rate between the fluorescent layer and the substrate (or a coating applied between substrate and fluorescent layer). In this way the etching will virtually stop at the interface, carrier 306.

After etching a fully structured fluorescent layer 308 is created as shown in step 310. As shown in 310 lands of layer 308 have a sufficient thickness and pits have a zero thickness.

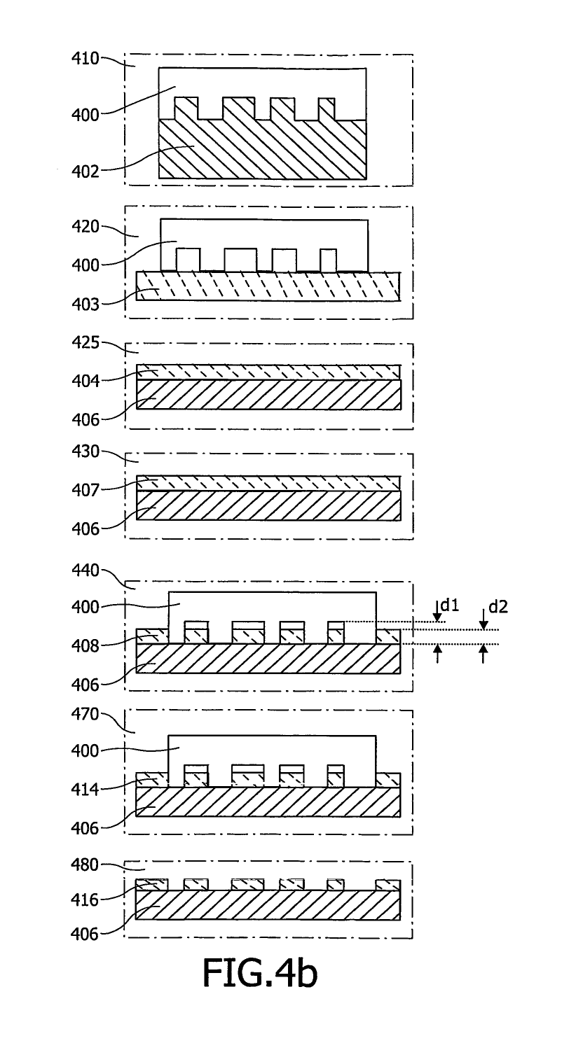

Process steps of producing a fluorescent information carrier disc in accordance with an embodiment of the invention are shown in FIG. 4a.

In step 410 a soft stamp 400 is cast in, e.g., PDMS (polydimethoxysiloxane) from a mold 402, which typically contains a required microstructure. The mold 402 can be a Ni shim, which is produced with existing stamper technology as used for injection molding of DVD substrates, except for a higher structure depth.

In step 420 the stamp 410 is transferred to a solid substrate 403 to facilitate handling.

In step 425 a substrate 406 (typically an optical substrate), is coated with a solution 404 of a fluorescent dye, like Coumarin-30 and a polymer, like polyvinylbutyral (PVB) or polyvinylalcohol (PVA), in a common solvent, like ethyl-lactate or ethanol. The concentration of the polymer in the solution 404 has been adjusted for the optimum solution viscosity for subsequent spinning and embossing process steps. The concentration of the dye in the solution 404 has been adjusted to the polymer to have maximum efficiency (avoid quenching).

Step 430 comprises spinning solution 404 to a layer 407 with a required thickness (typically in the order of magnitude of less than half the structure depth; see below why).

In step 440 stamp 400 is applied to layer 407 (typically a wet layer). Stamp 400 at least resides on the substrate 406 until a liquid film of solution 404 underneath stamp 400 (the stamp typically resembles a rubbery material) is squeezed out to form a structured layer 408 of solution 404. Interfacial forces typically perform the squeezing out. It is preferred that liquid film material that is being squeezed out moves in cavities 409 that are present in stamp 450. After the movement of the liquid film material thickness d1 of a cavity 409 should be larger than thickness d2 of the structured layer 408. Otherwise layer 407 was too thick. On the other hand if layer 407 is not thick enough, the structured layer 408 will not be thick enough. So in an optimum situation thickness 407 should be such that thickness d2 is almost as large as thickness d1. In other words: the surface of the pits (e.g., the upper surface of the squares of layer 416) versus the total surface of the stamp at the side where it contacts substrate 406 determines the maximum allowed thickness of layer 407.

In step 450 stamp 400 is released carefully.

Structured layer 408 is dried in step 460 at slightly elevated temperature to form dried structured layer 412. The process step described so far are cost effective and are compatible with processing steps on thin substrates. There is no thermal load on the dye. Stamp 400 can be reused. However a limitation comes from a required low viscosity of solution 404. The low viscosity is required in order to achieve a reasonable rate of material displacement underneath stamp 400. This leads to a reduced thickness of dried structured layer 412 after drying structured layer 408 in the case of a solvent, which is evaporated.

Alternative process steps of producing a fluorescent information carrier disc in accordance with an embodiment of the invention are shown in FIG. 4b. Steps 410, 420, 425, 430 and 440 are substantially similar as described for FIG. 4a.

In a preferred embodiment a solvent in layer 414 is used that is cured in step 470 to a polymer network after embossing (e.g., by UV irradiation that can start or speedup a polymerization reaction). It should be noted that step 470 of curing could be substantially simultaneously with step 440 of applying the stamp 400 forming structured layer 408. In case of curing, the polymer is not necessary, as a special (active) solvent is used that will cure into a polymer (the active solvent typically forms radicals under exposure by UV-light that will in turn react to form the polymer). A curing process can be performed within a second. Typically the curing process executed in an oxygen poor environment such as a nitrogen gas environment.

A drying process may involve a diffusion process of the solvent that is residing in layer 414 into stamp 400. Stamp 400 can be used multiple times but care should be taken that it does not get too saturated with the solvent or else the diffusion process would slow down. The drying process can be executed quite fast as the amount of solvent is limited, e.g., due to the limited thickness of layer 414 (e.g., typically in the order of magnitude of less than 1 micrometer). As an alternative or in combination, drying may also be performed after layer 416 has been formed. A drying process may be sped-up by, e.g., elevating the ambient temperature.

Alternatively in another preferred embodiment of step 470, a chemical reaction of certain components of layer 414 solidifies layer 414.

In step 480 a full structured layer 416 is formed and retained on substrate 406 after removing stamp 400.

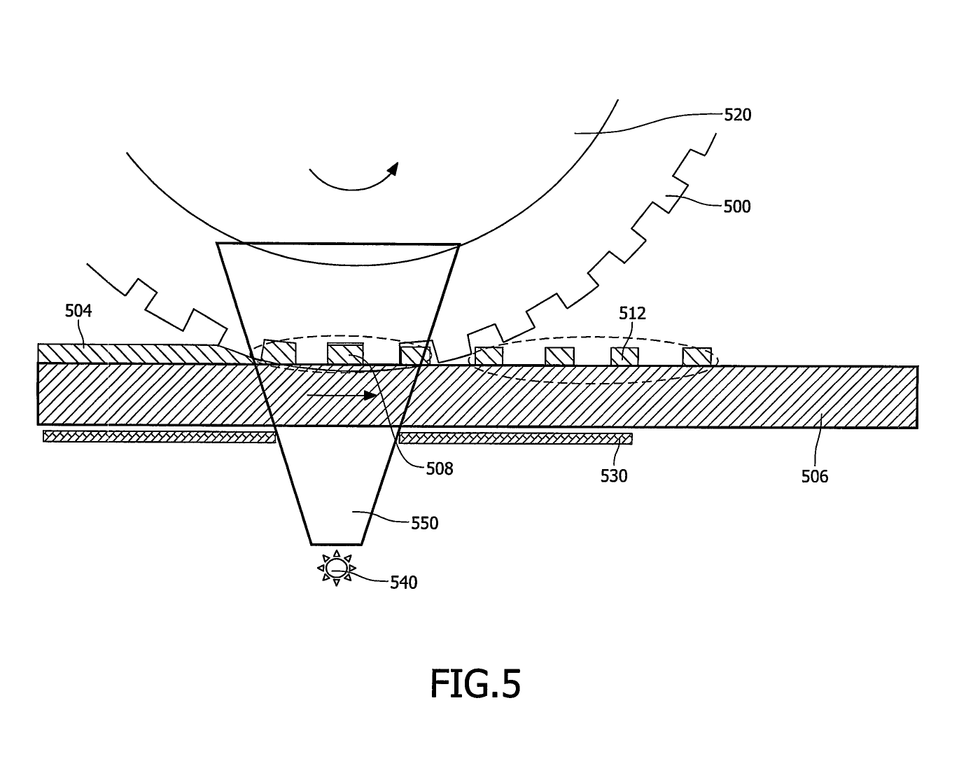

It should be noted that FIGS. 4a and 4b, 5, 6, and 7 show structures not drawn to scale. Also structures are typically drawn only partial in order to improve their function more clear. Moreover it is possible that a shown part of the stamp, e.g., stamp 400, is actually part of a bigger stamp with, e.g., a curved shape. For instance, part of a curved stamp is above layer 404 and 407 and another part of the curved stamp is forming structured layer 408 or 414 as yet another part of the curved stamp is above 412 or 416. FIGS. 5, 6 and 7 will clarify this in more details.

FIG. 5 shows one embodiment of an apparatus for producing a fluorescent information carrier disc in accordance with the invention that also shows stages or steps of producing the disc.

The apparatus shown in FIG. 5 comprises rotating drum 520, soft stamp 500 located at the outer surface of drum 520, reticle 530 with a hole 550 in it and UV-source 540. FIG. 5 also shows an information carrier comprising substrate 506, newly formed structured layer 512, solution 504 that has been applied on substrate 506, and new structures 508 being formed. The information carrier is moving relative with respect to the apparatus as the drum 520 and stamp 500 are rotating whereby the speed of the outer surface of the stamp 500 is substantially the same as that of the information carrier at the point where new structures 508 are being formed. The speed of rotating drum 520 determines the time that stamp 600 is in contact with structures 608. UV-source 540 irradiates new structures 508 though hole 550 and through substrate 506 with UV-light. The UV-light will start a polymerization reaction in structures 508 to eventually produce a newly formed structured layer 512. Layer 512 typically comprises pits (the squares of 512) and lands (the empty spaces between the squares). The UV-light activates a photo-initiator that initiates a polymerization reaction of a solvent in solution 504. The reaction is in progress in new structures 508. The photo-initiator can, when being exposed to UV-light, e.g., dissociate into radicals that in turn can start a reaction with a reactive solvent to produce a polymer. Solution 504 typically comprises a reactive solvent and a fluorescent dye. In an alternative embodiment of the apparatus in FIG. 5, hole 550 can be located, at least partly under layer 512 since it is also possible to start the reaction until after stamp 500 releases from substrate 506 forming layer 512.

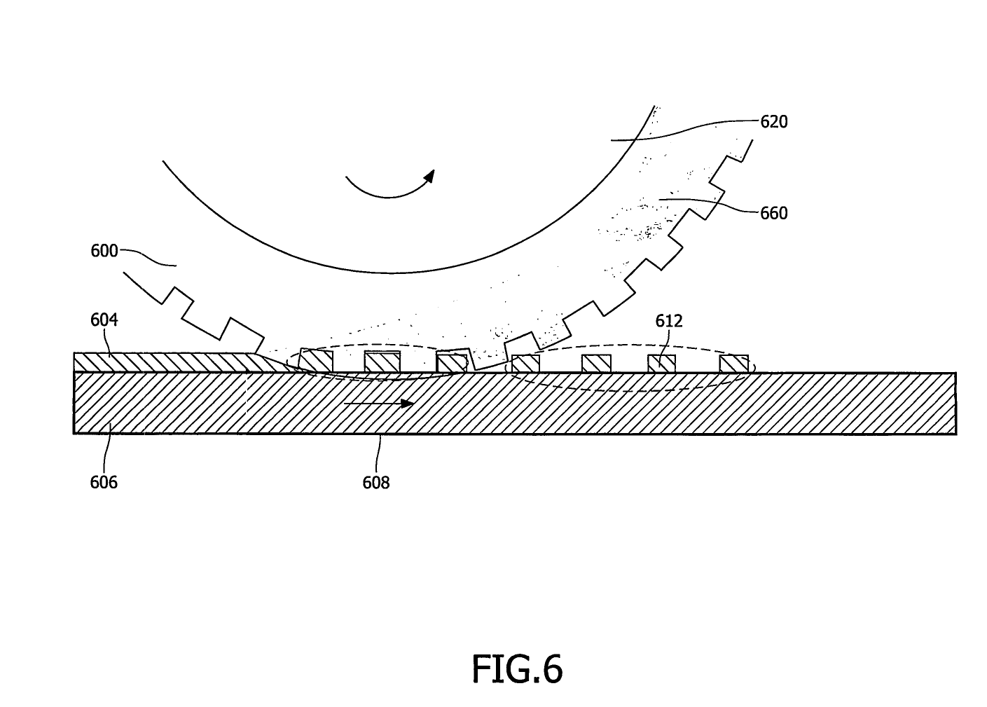

FIG. 6 shows another embodiment of an apparatus for producing a fluorescent information carrier disc in accordance with the invention that also shows stages or steps of producing the disc.

The apparatus shown in FIG. 6 comprises rotating drum 620, soft stamp 600 located at the outer surface of drum 620. FIG. 6 also shows an information carrier comprising substrate 606, newly formed structured layer 612, solution 604 that has been applied on substrate 606, and new structures 608 being formed. The information carrier is moving relative with respect to the apparatus as the drum 620 and stamp 600 are rotating whereby the speed of the outer surface of the stamp 600 is substantially the same as that of the information carrier at the point where new structures 608 are being formed. Solution 604 typically comprises a solvent, a fluorescent dye and a polymer. When stamp 600 is touching or in substantially close enough proximity of structures 606 the solvent will substantially diffuse into soft stamp 600 as the soft stamp 600 moves over the information carrier. A result is shown in FIG. 6 as diffused solvent 660. Structures 608 eventually produce newly formed structured layer 612. Layer 612 typically comprises pits (the squares of 612) and lands (the empty spaces between the squares). In an alternative embodiment of the apparatus of FIG. 6, the solvent can be removed from solution 604 after newly formed structured layer 612 has been formed by a drying process. It is possible to achieve enough solvent removal any solvent diffusion into soft stamp 600 but a combination is also possible.

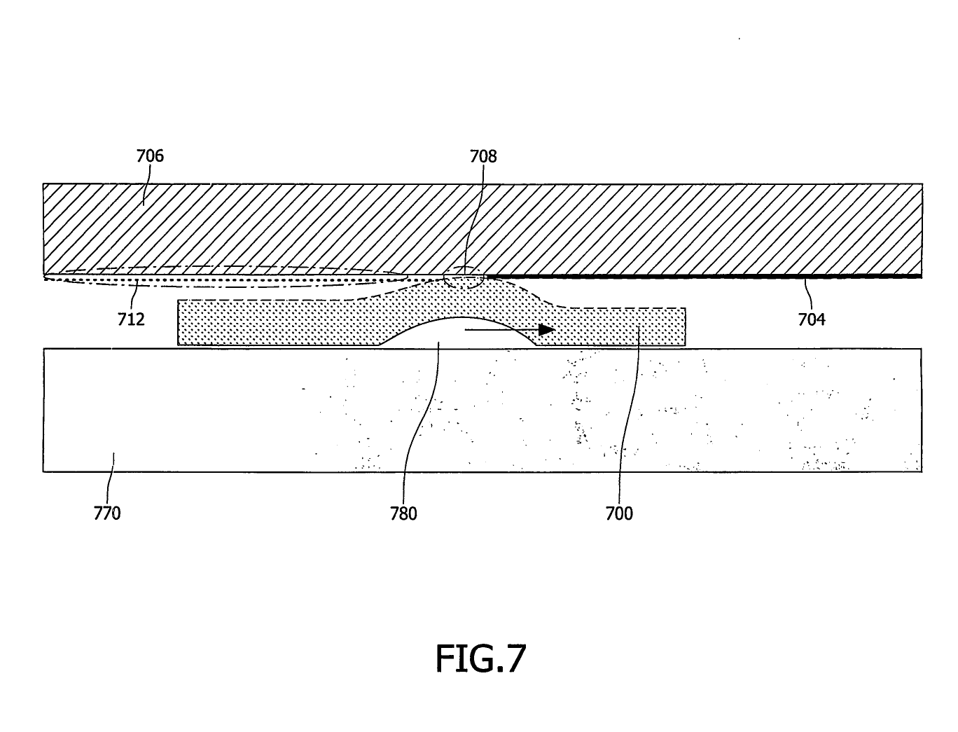

The apparatus shown in FIG. 7, a so-called wave printing apparatus, comprises a pressure application substrate 770 and soft stamp 700. FIG. 7 also shows an information carrier comprising substrate 706, newly formed structured layer 712, solution 704 that has been applied on substrate 706, and new structures 708 being formed. A traveling wave 780 is moving relative with respect to the apparatus and the information carrier. Substrate 770 is adapted to induce a traveling wave 780 in stamp 700. Wave 780 moves from one side of stamp 700 to the other side. In the process stamp 700 will make contact with solution 704 and substrate 708 thereby forming layer 712. The speed of wave 780 needs to be well controlled. Solution 704 typically comprises a solvent, a fluorescent dye and a polymer. In one embodiment, when stamp 700 is touching or in substantially close enough proximity of structures 706 the solvent will substantially diffuse into soft stamp 700 as the soft stamp 700 moves over the information carrier. Structures 708 eventually produce newly formed structured layer 712. Layer 712 typically comprises pits (the squares of 712) and lands (the empty spaces between the squares). In an alternative embodiment of the apparatus of FIG. 7, the solvent can be removed from solution 704 after newly formed structured layer 712 has been formed by a drying process. It is possible to achieve enough solvent removal any solvent diffusion into soft stamp 700 but a combination is also possible.

One of ordinary skill in the art will recognize that alternative schemes can be devised to create a fluorescent layer by making tweaks in the steps described.

The foregoing merely illustrates the principles of the invention. It will thus be appreciated that those skilled in the art will be able to devise various arrangements which, although not explicitly described or shown herein, embody the principles of the invention and are thus within its spirit and scope.

1. A method of producing an optical information layer on a substrate, the method comprising the steps of:
spinning (430) of a solution on the substrate, wherein the solution comprises a fluorescent dye;
contacting (440) a structured stamp on the solution and the substrate forming a structured layer;
solidifying (470) the structured layer; and
releasing (480) the stamp from the structured layer and the substrate.

2. The method of claim 1, comprising the step of casting the stamp from a mold; wherein the mold comprises a microstructure.

3. The method of claim 2, wherein the stamp comprises a rubbery material comprising polydimethoxysiloxane (PDMS).

4. The method of claim 3, wherein the solution further comprises a solvent and a polymer and wherein the step of solidification comprises diffusing a substantial part of the solvent into the stamp.

5. The method of claim 2, wherein the mold comprises one of a master shim and a Ni shim obtained from the master shim.

6. The method of claim 1, wherein the step of contacting comprises squeezing out the solution from under a bottom part of the stamp so that the bottom part contacts the carrier.

7. The method of claim 2, wherein the solution comprises an active solvent and wherein the step of solidification comprises curing a substantial part of the active solvent to a polymer network.

8. The method of claim 7, wherein the curing comprises irradiating the solution with UV-light.

9. The method of claim 1, wherein the dye comprises Coumarin-30.

10. A method of producing an optical information layer on a substrate, the method comprising the steps of:
spinning (430) of a solution on the substrate, wherein the solution comprises a fluorescent dye;
contacting (440) a structured stamp on the solution and the substrate forming a structured layer; and
releasing (450) the stamp from the structured layer and the substrate.
solidifying (460) the structured layer.

11. The method of claim 10, wherein the stamp comprises a rubbery material comprising polydimethoxysiloxane (PDMS).

12. The method of claim 10, wherein the dye comprises Coumarin-30 and wherein the solution further comprises:
a polymer; and
a solvent

13. The method of claim 10, wherein the step of solidifying comprises drying the structured layer by evaporation a substantial amount of the solvent from the structured layer.

14. The method of claim 13, wherein the step of drying comprises elevating the ambient temperature.

15. The method of claim 10, comprising the steps of:
adjusting the concentration of polymer in the solution in order to achieve substantial optimal viscosity for the spinning, the contacting, and the residing step; and
adjusting the concentration of dye in the solution to that of the polymer in order to achieve a substantial maximum efficiency in order to avoid quenching.

16. The method of claim 10, wherein
the polymer comprises one of polyvinylbutyral (PVB) and polyvinylalcohol (PVA); and
the solvent comprises one of ethyl-lactate and ethanol.

17. A method of producing an optical information layer on a substrate, the method comprising the steps of:
spinning of a solution that comprises a fluorescent dye on the substrate;
contacting a structured stamp on the solution;
residing the stamp on the solution until forming a structured solution, wherein the structured solution comprises lands and pits;
releasing the stamp from the structured solution; and
etching (300) the structured solution perpendicular to its surface until the thickness of the lands becomes substantially zero (310).

18. An optical storage data disc comprising:
an information layer that includes a fluorescent dye; and
a substrate (406) on which the information layer resides; wherein the information layer comprises a structure of lands and pits (412, 416) and wherein
the lands have a thickness of substantially zero; and
the pits have a finite thickness.

19. The optical storage data disc of claim 18, comprising a multiple of information layers of which at least one information layer comprises a read-only memory.

20. An apparatus for producing an optical information layer on a substrate, the apparatus comprises:
a rotatable drum (520) on which at an outer surface a soft stamp (500) can be attached;
a reticle (530) with a hole;
an irradiation source (540); and
means for moving a substrate with a liquid solution, whereby the substrate can be located in between the outer surface of the stamp and the reticle and whereby the substrate can be moved with a direction and velocity substantial close to that of the outer surface of the stamp, wherein
the irradiation source is placed such that it can irradiate the substrate with the solution through the hole towards the drum.
